(19) United States
(12) Patent Application Publication
(10) Pub. No.: US 2019/0299585 A1
(43) Pub. Date: Oct. 3, 2019

(54) LAMINATING APPARATUS

(71) Applicant: CORNING INCORPORATED, CORNING, NY (US)

(72) Inventors: Sangbum CHOI, Suwon-si, Gyeonggi-do (KR); Sanghoon LEE, Cheonan-si (KR)

(21) Appl. No.: 16/307,645

(22) PCT Filed: Jun. 7, 2017
(86) PCT No.: PCT/KR2017/005896

§ 371 Date: Dec. 6, 2018

(30) Foreign Application Priority Data
Aug. 6, 2016 (KR) 10-2016-0071165

(51) Int. Cl. B32B 38/18; B32B 38/00; B32B 37/16; B32B 37/00; B32B 17/10

(52) U.S. Cl. CPC B32B 38/1833; B32B 38/0004; B32B 37/16; B32B 2309/72; B32B 17/10954; B32B 2309/14; B32B 2315/08; B32B 37/0015

(57) ABSTRACT

A laminating apparatus may include a first conveyor unit having a conveyance speed; a laminating unit disposed downstream of the first conveyor unit, wherein the laminating unit laminates a surface of a glass sheet with a film in a single stroke with the conveyance speed; and at least one first imaging unit disposed upstream of the laminating unit, the at least one first imaging unit correcting a position of the glass sheet entering the laminating unit.

### TECHNICAL FIELD

This application claims the benefit of priority under 35 U.S.C. § 119 of Korean Patent Application Serial No. 10-2016-0071165 filed on Jun. 8, 2016, the content of which is relied upon and incorporated herein by reference in its entirety.

The present disclosure generally relates to a laminating apparatus. The present disclosure also relates to a laminating apparatus configured to laminate the surface of a glass sheet with a film with superior quality and at a higher speed.

### BACKGROUND ART

A film laminating apparatus is generally an apparatus for laminating the surface of a glass sheet with a film while the glass sheet is being conveyed along a processing line to protect the glass sheet from external impurities, thereby maintaining the surface quality thereof. Conventional film laminating apparatuses laminate the surface of a glass sheet with a film with four strokes, while a heavy carriage equipped with a laminating roller moves in a vertical direction along a glass sheet the top portion of which is gripped by a carrier gripper. However, such a film laminating apparatus may result in several problems. Such problems include (1) a film attachment position that may be altered due to being influenced by changes in the equipment setup, the shape of a glass sheet, disturbances, or the like; (2) a glass sheet may be broken due to warping; (3) a film may not be stripped, or may be excessively stripped, wrinkled, or stained. In addition, the thinner and larger a glass sheet becomes, the higher a degree of warping and variations in the flatness become. Such a high degree of warping may exacerbate the above-mentioned problems.

To overcome these problems, lamination speed should be reduced. However, when the speed of lamination is reduced, the ability to manufacture thin sheets at a high production rate cannot be obtained. Thus, there is a need in the art to provide higher and consistent lamination speeds while maintaining a high production rate.

The information disclosed in the Background section is only provided for a better understanding of the background and should not be taken as an acknowledgment or any form of suggestion that this information forms prior art that would already be known to a person skilled in the art.

### DISCLOSURE OF INVENTION

### Solution to Problem

According to an aspect, a laminating apparatus may include a first conveyor unit having a conveyance speed; a laminating unit disposed downstream of the first conveyor unit, wherein the laminating unit laminates a surface of a glass sheet with a film in a single stroke with the conveyance speed; and at least one first imaging unit disposed upstream of the laminating unit, the at least one first imaging unit correcting a position of the glass sheet entering the laminating unit.

The methods and apparatuses of the present disclosure have other features and advantages that will be apparent from or that are set forth in greater detail in the accompanying drawings which are incorporated herein, and in the following Detailed Description, which together serve to explain certain principles of the present disclosure.

### BRIEF DESCRIPTION OF DRAWINGS

FIG. 1 is an illustration of an exemplary laminating apparatus according to some embodiments;

FIG. 2 is an illustration of an exemplary laminating apparatus according to some embodiments;

FIG. 3 is a plan view of a first floating table of an exemplary laminating apparatus according to some embodiments;

FIG. 4 is a side view of the first floating table illustrated in FIG. 3;

FIG. 5 is a partial plan view of an exemplary laminating apparatus according to some embodiments;

FIG. 6 is a partial side view of an exemplary laminating apparatus according to some embodiments; and

FIG. 7 is a plan view of a belt conveyor of an exemplary laminating apparatus according to some embodiments.

### MODE FOR THE INVENTION

Reference will now be made in detail to a laminating apparatus according to an exemplary embodiment of the present disclosure, examples of which are illustrated in the accompanying drawings and described below, so that a person skilled in the art to which the present disclosure relates could easily put the present disclosure into practice.

Throughout this document, reference should be made to the drawings, in which the same reference numerals and symbols will be used throughout the different drawings to designate the same or like components. In the following description, detailed descriptions of known functions and components incorporated herein will be omitted in the case that the subject matter of the present disclosure is rendered unclear by the inclusion thereof.

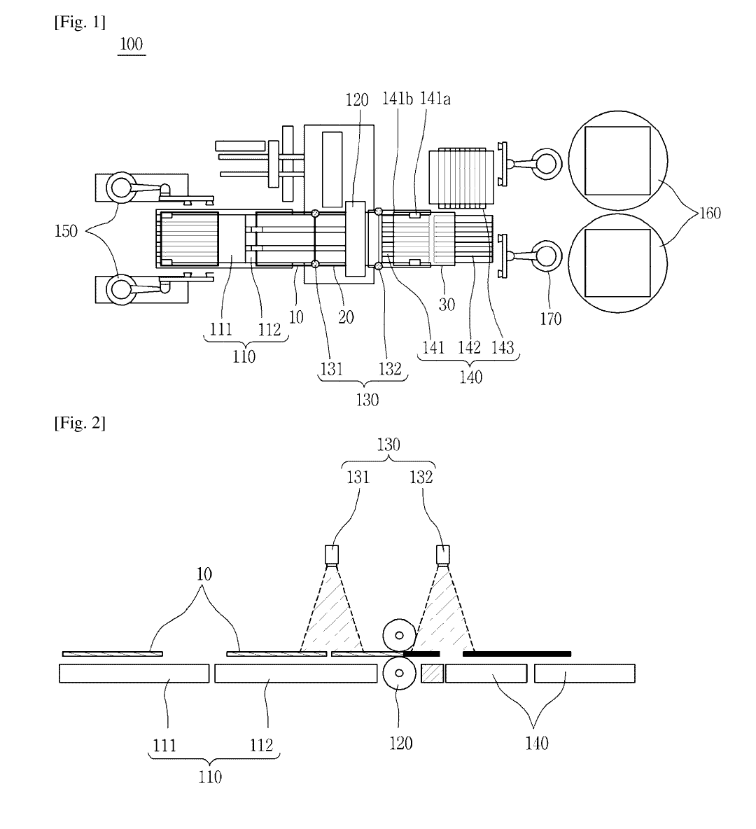

Referring to FIG. 1 and FIG. 2, a laminating apparatus 100 according to an exemplary embodiment of the present disclosure includes an apparatus for laminating a glass sheet 10 conveyed horizontally with a film to protect the glass sheet 10 from external impurities, thereby maintaining the surface quality of the glass sheet 10. The laminating apparatus 100 can include a first conveyor unit 110, a laminating unit 120, imaging units 130, and a second conveyor unit 140.

The first conveyor unit 110 can be disposed upstream of the laminating unit 120. The first conveyor unit 110 horizontally conveys the glass sheet 10 toward the laminating unit 120. Here, the glass sheet 10 may be loaded by the first loading unit 150. One or more first loading units 150 may be disposed upstream of the first conveyor unit 110. In this embodiment, the glass sheet 10 may stand by for lamination at a location upstream of the first conveyor unit 110 after having been conveyed in a vertically-erect position, and the first loading unit 150 loads the glass sheet 10 in the horizontal position onto the first conveyor unit 110 through a circular motion.

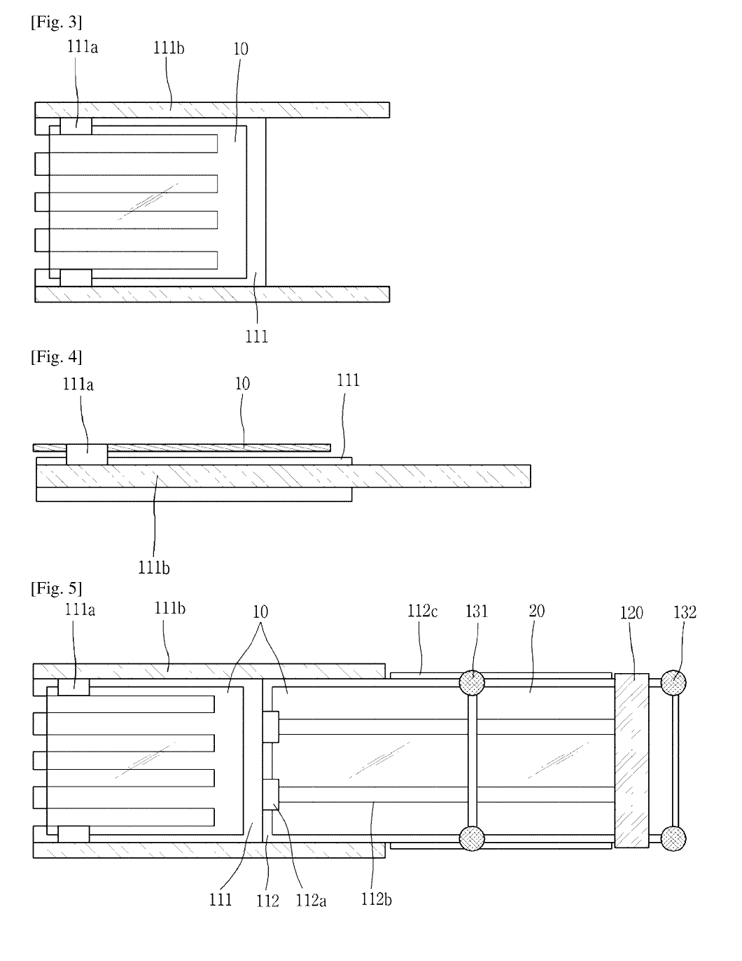

To prevent the horizontally conveyed glass sheet 10 from being damaged, the first conveyor unit 110 can include a first floating table 111 and a second floating table 112 supporting the glass sheet 10 without contact. As illustrated in FIG. 3 and FIG. 4, the first floating table 111 includes first grippers 111a and first linear modules 111b to horizontally convey the glass sheet 10 with minimal contact. When the glass sheet 10 is loaded onto the first floating table by the first loading unit 150, the first grippers 111a grip both side edges of the glass sheet 10. In some embodiments, the first grippers 111a may be provided as a gripper set including two grippers opposing each other. However, this is merely illustrative, and the number of the first grippers 111a is not limited thereto. The first linear modules 111b guide movement of the first grippers 111a mounted thereon such that the first grippers 111a move along respective linear paths. In some embodiments, the first linear modules 111b are disposed on both sides of the first floating table 111. Thus, when the first grippers 111a grip both side edges of the glass sheet 10, the glass sheet 10 can be horizontally conveyed toward the second floating table 112 along a path established by the first linear module 111b.

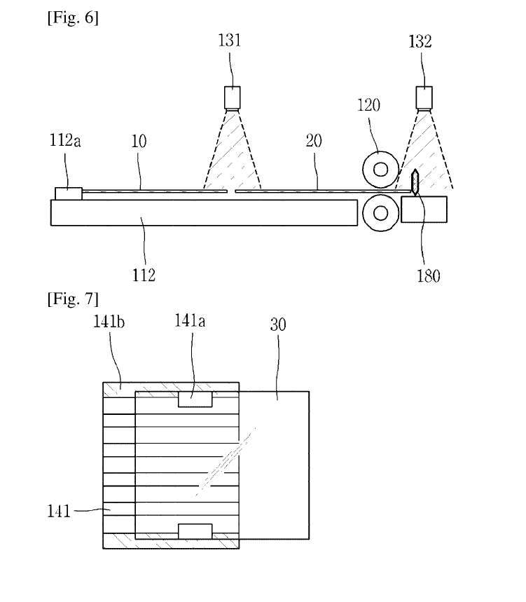

The second floating table 112 can be disposed downstream of the first floating table 111. In some embodiments, the second floating table 112 is disposed between the first floating table 111 and the laminating unit 120. As illustrated in FIG. 5 and FIG. 6, the second floating table 112 can include second grippers 112a and second linear modules 112b. A glass sheet 10 conveyed by the second floating table 112 can be introduced into an exemplary laminating unit 120. The second grippers 112a of the second floating table 112 grip the trailing edge of the glass sheet 10, to thereby allow the glass sheet 10 to enter the laminating unit 120. Although the second grippers 112a are provided as a plurality of grippers as illustrated in FIG. 5, this is merely illustrative and the number of the second grippers 112a is not limited thereto. Similarly, the second linear modules 112b extend along the longitudinal centerline of the second floating table 112 to guide movements of the second grippers 112 mounted thereon such that the second grippers 112a move along a linear path. Thus, when the second grippers 112a holding the central portion of the trailing edge of the glass sheet 10 move along the second linear modules 112b, the glass sheet 10 moves downstream toward the laminating unit 120 while remaining in a horizontal position.

In some embodiments, the glass sheet 10 conveyed over the first floating table 111 and the second floating table 112 may be warped (e.g., upwardly convex) by air blown from the first floating table 111 and the second floating table 112 which support the glass sheet 10 without contact. Thus each of the first floating table 111 and the second floating table 112 can include a plurality of vent holes (not shown) through which air existing over the glass sheet 10 can be discharged to prevent the glass sheet 10 from being warped. The vent holes also allow controlling of the air pressure therethrough. In some embodiments, the plurality of vent holes can be aligned or spaced appropriately along the first floating table 111 and the second floating table 112 to allow a uniform amount of air to be discharged.

The second floating table 112 can also include a plurality of brush rollers disposed on portions 112c of both side edges thereof. As the second grippers 112a of the second floating table 112 grip the central portion of the trailing edge of the glass sheet 10, the side edges of the glass sheet 10 may sag downwardly while being horizontally conveyed. Thus, the plurality of brush rollers come into rolling contact with the side edges of the glass sheet 10 to support the conveyance of the glass sheet 10 and to thereby prevent the side edges of the glass sheet 10 from sagging.

The laminating unit 120 is generally a device for laminating the surface of the glass sheet 10 introduced from the first conveyor unit 110 with a film. In this regard, the laminating unit 120 is disposed downstream of the first conveyor unit 110, and in some embodiments downstream of the second floating table 112. In some embodiments, the laminating unit 120 may be provided as a set of rollers that laminates the surface of the horizontally-conveyed glass sheet 10 with a film in a single stroke or pass of the glass sheet 10 past the set of rollers, keeping pace with the speed at which the glass sheet 10 is conveyed. Conventionally, film lamination was performed with four strokes on a glass sheet 10 by moving a laminating roller. In contrast, exemplary embodiments perform film lamination on the surface of the glass sheet 10 while the glass sheet 10 is passing through the laminating unit 120 in a fixed position. When film lamination is performed in this manner, the lamination speed can be increased and continuous lamination can be performed on plural glass sheets. It is also possible to minimize degradations in the quality of lamination or the fracture of the glass sheet 10 due to the warping of the glass sheet, the shaking of the glass sheet during lamination, disturbances, or the like. For example, conventionally the cycle time of the lamination of a glass sheet having a specific size was 21.0 seconds. In contrast when lamination is performed using exemplary embodiments in a single stroke while horizontally conveying a glass sheet having the same size, the cycle time of the lamination was reduced to 10.5 seconds. According to exemplary embodiments, it is thus possible to increase the laminating speed by about 50% with respect to conventional vertical laminating methods to thereby increase productivity. In addition, lamination on a large ultrathin glass sheet becomes possible. To continuously laminate the surfaces of a plurality of glass sheets 10 that are horizontally conveyed with a film with high quality, positions of the glass sheets 10 sequentially entering and leaving the laminating unit 120 can be detected through the use of imaging units 130.

For example, imaging units 130 can be disposed upstream and downstream of the laminating unit 120. The imaging units 130 can be used to detect the position of plural glass sheets entering the laminating unit 120 and the position of plural glass sheets leaving the laminating unit 120.

As depicted in FIG. 1, exemplary embodiments can process a plurality of glass sheets. For example, a first glass sheet 10 is depicted as being conveyed by the first conveyor unit 110 prior to entrance into the laminating unit 120, a second glass sheet 20 is depicted as being laminated by the laminating unit 120, and a third glass sheet 30 is depicted as being conveyed by the second conveyor unit 140 from the laminating unit 120. To detect the positions of the glass sheets 10, 20, 30, an exemplary imaging unit 130 can include first imaging units 131 and second imaging units 132 whereby the first imaging units 131 are disposed upstream of the laminating unit 120 in positions to detect a first distance between a leading edge of the first glass sheet 10 and a trailing edge of the second glass sheet 20. The first imaging units 131 may also be disposed over both the side edges of the glass sheets to detect these edges. However, this is merely an example, and the number of the first imaging units 131 is not specifically limited. The first imaging units 131 detect the first distance by taking images thereof and align the first glass sheet 10 and the second glass 20 based on the detected distance. For example, the first imaging units 131 may align the first glass sheet 10 and the second glass sheet 20 such that the first distance between the leading edge of the glass sheet 10 and the trailing edge of the laminating glass 20 is between 1 mm to 10 mm, between 2 mm to 9 mm, between 3 mm to 8 mm, between 4 mm to 7 mm, or about 6 mm.

Exemplary second imaging units 132 can be disposed downstream of the laminating unit 120 in positions to detect a leading edge of the second glass sheet 20 (and/or a trailing edge of the third glass sheet 30). The second imaging units 132 may also be disposed over both the side edges of the glass sheets to detect these edges. However, this is merely an example, and the number of the second imaging units 132 is not specifically limited. The second imaging units 132 detect a position of the leading edge of the second glass sheet 20 (and/or a position of the trailing edge of the third glass sheet 30) by taking images thereof. As depicted, the third glass sheet 30 and the second glass sheet 20 are connected via the film, with major surface(s) of the third glass sheet 30 and the second glass sheet 20 outside of the laminating unit 120 being laminated with the film. The portion of the film between the trailing edge of the third glass sheet 30 and the leading edge of the second glass sheet 20 can be cut by a cutting unit 180 to produce a laminated glass sheet. In some embodiments, when the trailing edge of the laminated glass sheet arrives under the second imaging units 132, the conveyance of the laminated glass sheet 30 is stopped, and the cutting unit 180 cuts the film. In other embodiments, the cutting unit 180 travels with the speed of the sheet to thereby cut the film during movement of the sheet. In some embodiments, the position at which the film will be cut can be set based on a position of the second glass sheet 20 (and/or a position of the third glass sheet 30) detected by the second imaging units 132. In an exemplary embodiment, the cutting unit 180 can cut a portion of the film at a predetermined distance downstream of the leading edge of the second glass sheet 20 detected by the second imaging unit 132. In an alternative embodiment, the cutting unit 180 can cut a portion of the film at a predetermined distance upstream of the trailing edge of the third glass sheet 20 detected by the second imaging unit 132. When positions of the first glass sheet 10, the second glass sheet 20, and the third glass sheet 30 are detected using the imaging units 130 as described above, the reliability and accuracy of an exemplary film lamination process can be provided, and it is therefore possible to manufacture a high-quality laminated glass sheet.

In some embodiments, the second conveyor unit 140 can be disposed downstream of the laminating unit 120. In additional embodiments, the second conveyor unit 140 can include a plurality of belt conveyors 141, 142, and 143. In some embodiments, the belt conveyor 141 may include third grippers 141a and third linear modules 141b. The third grippers 141a may grip both side edges of the glass sheet 30. In some embodiments, the third grippers 141a may be provided as a gripper set including two grippers opposing each other. However, this is merely illustrative, and the number of the third grippers 141a is not limited thereto. The third linear modules 141b guide movement of the third grippers 141a mounted thereon such that the third grippers 141a move along respective linear paths. In some embodiments, the third linear modules 141b may be disposed on both sides of the belt conveyor 141.

The laminating apparatus 100 may also include packing units 160 disposed downstream of the second conveyor unit 140. In some embodiments, individual laminated glass sheets 30 conveyed by the second conveyor unit 140 can be loaded onto the packing units 160 to be packed into containers. In some embodiments, the packing unit 160 can include a turn table and a plurality of packing units 160 may also be provided. The laminating apparatus 100 according to some embodiments may further include second loading units 170 which serve to load individual laminated glass sheets 30 conveyed by the second conveyor unit 140 onto the packing units 160. In some embodiments, the number of the second loading units 170 may correspond to the number of the packing units 160.

Operation of the Laminating Apparatus

A glass sheet 10 can be loaded onto the first floating table 111 through a circular motion of the first loading unit 150 whereby the first grippers 111a grip both the side edges of the glass sheet 10 and then move along the first linear modules 111b toward the second floating table 112. When the glass sheet 10 arrives over the second floating table 112, the second grippers 112a grip the trailing edge of the glass sheet 10 and then move along the second linear modules 112b toward the laminating unit 120. At the same time, a subsequent glass sheet is loaded onto the first floating table 111 by the first loading unit. Through the same processes, a plurality of glass sheets can be continuously conveyed.

When a glass sheet enters the laminating unit 120, the first imaging units 131 align the glass sheets such that the distance between the trailing edge of a first glass sheet and the leading edge of a second glass sheet is between 1 mm to 10 mm, between 2 mm to 9 mm, between 3 mm to 8 mm, between 4 mm to 7 mm, or about 6 mm. The first glass sheet enters the laminating unit 120 whereby a surface of the first glass sheet becomes laminated with a film. After the laminating operation, the first glass sheet leaves the laminating unit 120, and the second glass sheet is being laminated and is positioned upstream of the first glass sheet. In some embodiments, the conveyance of the glass sheets 10, 20, and 30 can be stopped to allow the cutting unit 180 to cut the portion of the film between the trailing edge of the third glass sheet 30 and the leading edge of the second glass sheet 20 based on the distance between the trailing edge of the third glass sheet 30 and a position of the leading edge of the second glass sheet 20 (and/or a position of the trailing edge of the third glass sheet 30). In other embodiments, the cutting unit 180 travels with the speed of the sheet to thereby cut the film during movement of the sheet. Afterwards, the laminated glass sheet 30 separated from the second glass sheet 20 can be conveyed by the second conveyor unit 140, loaded onto the packing units 160 by the second loading units 170, and are packed by the packing units 160 in a container (not shown).

Thus, an exemplary laminating apparatus 100 can laminate a glass sheet 10 with a film in a single stroke while horizontally conveying the glass sheet 10 through the laminating unit 120 in a fixed position using the first conveyor unit 110. In addition, the laminating apparatus 100 can detect positions of glass sheets before and after the laminating operation using exemplary imaging units 130. In some embodiments, the laminating apparatus 100 can prevent or minimize sagging or warping of glass sheets during the conveyance thereof by applying uniform pressure to the glass sheets 10 using vent holes, and/or brush rollers. Using embodiments described herein, it becomes possible to improve the speed, reliability, and accuracy of a lamination process to thereby manufacture a high volume of high-quality laminated glass sheets in a short period of time.

The foregoing descriptions of specific exemplary embodiments of the present disclosure have been presented with respect to the drawings. They are not intended to be exhaustive or to limit the present disclosure to the precise forms disclosed, and obviously many modifications and variations are possible for a person having ordinary skill in the art in light of the above teachings.

It is intended therefore that the scope of the present disclosure not be limited to the foregoing embodiments, but be defined by the Claims appended hereto and their equivalents.

1. A laminating apparatus comprising:
a first conveyor unit having a conveyance speed;
a laminating unit disposed downstream of the first conveyor unit, wherein the laminating unit laminates a surface of a glass sheet with a film in a single stroke with the conveyance speed; and
at least one first imaging unit disposed upstream of the laminating unit, the at least one first imaging unit correcting a position of the glass sheet entering the laminating unit.

2. The laminating apparatus according to claim 1, wherein the first conveyor unit comprises a first floating table including first grippers gripping side edges of the glass sheet and first linear modules guiding the first grippers in a linear direction.

3. The laminating apparatus according to claim 2, wherein the first conveyor unit further comprises a second floating table disposed downstream of the first floating table, wherein the second floating table includes at least one second gripper gripping a trailing edge of the glass sheet and at least one second linear module guiding the at least one second gripper in a linear direction.

4. The laminating apparatus according to claim 3, wherein each of the first floating table and the second floating table has a plurality of vent holes to discharge air existing over each of the first floating table and the second floating table to control a pressure of the air.

5. The laminating apparatus according to claim 3, wherein the second floating table includes a plurality of brush rollers to support the side edges of the glass sheet.

6. The laminating apparatus according to claim 1, wherein the at least one first imaging unit detects and aligns a first distance between a leading edge of the glass sheet and a trailing edge of a preceding glass sheet directly preceding the glass sheet.

7. The laminating apparatus according to claim 1, further comprising a second conveyor unit disposed downstream of the laminating unit, the second conveyor unit conveying the glass sheet leaving the laminating unit.

8. The laminating apparatus according to claim 7, wherein the second conveyor unit comprises a plurality of belt conveyors.

9. The laminating apparatus according to claim 1, further comprising at least one second imaging unit disposed downstream of the laminating unit, the at least one second imaging unit detecting a position of the glass sheet leaving the laminating unit.

10. The laminating apparatus according to claim 9, further comprising a cutting unit cutting the film extending from the glass sheet, wherein the laminating apparatus determines a position of a portion of the film to be cut based on the position of the glass sheet.

11. The laminating apparatus according to claim 1, further comprising a first loading unit disposed upstream of the first conveyor unit, wherein the first loading unit loads the glass sheet onto the first conveyor unit.

12. The laminating apparatus according to claim 1, further comprising:
a second conveyor unit disposed downstream of the laminating unit, the second conveyor unit conveying the glass sheet leaving the laminating unit; and
a packing unit disposed downstream of the second conveyor unit.
